(19) United States
(12) Patent Application Publication
(10) Pub. No.: US 2004/0186859 A1
(43) Pub. Date: Sep. 23, 2004

(54) File access based on file digests

(75) Inventor: Lawrence Butcher, Mountain View, CA (US)

Correspondence Address: BRIAN M BERLINER, ESQ, O'MELVENY & MYERS, LLP, 400 SOUTH HOPE STREET, LOS ANGELES, CA, 90071-2899, US

(73) Assignee: SUN MICROSYSTEMS, INC.

(21) Appl. No.: 10/393,226

(22) Filed: Mar. 20, 2003

(51) Int. Cl. G06F 17/30

(52) U.S. Cl. 707/200

(57) ABSTRACT

A method and apparatus are provided. The method and apparatus include determining a plurality of first file digests corresponding to a plurality of files in a file system and providing a directory of the plurality of first file digests.

### BACKGROUND OF THE INVENTION

1. Field of the Invention

This invention relates generally to computer software and, more particularly, to a method and an apparatus for locating files without knowing individual file names and/or file paths.

2. Description of the Related Art

Files are popularly used by computer programs. Files are frequently opened by name. Computer systems are typically built to access and manipulate files. In order to find a file to access and manipulate, the computer user typically needs to know the file name. Frequently, the computer user typically needs to know the full file name and file path. Once the computer user has this conventionally necessary file information (file name and/or full file name and file path), the computer user can ask the computer operating system (OS) to let the computer user read, write and/or otherwise manipulate the file.

Files are used for many purposes. Files are used to store programs, libraries, images of running programs, user data, and the like. Within a single computer, conventional File Access by Path and Name works well. Within a local area network (LAN), conventional File Access by Path and Name often works well, too.

However, differences in the ways File Systems are mounted can make the conventional File Access by Path and Name scheme fail. For example, if a computer user tries to go to a different computer system than the one the computer user typically uses, files may be in different places and/or may have different names. The computer user typically expects that if the simple access-by-name scheme, one that simply opens files by name, were to fail, the computer user will not be able to find files and so will not be able to get work done.

The present invention is directed to overcoming, or at least reducing the effects of, one or more of the problems set forth above. For example, embodiments of the present invention are directed methods and apparatus for allowing a computer user to locate a plurality of files without knowing individual file names and/or paths of the plurality of files

### SUMMARY OF THE INVENTION

In one aspect of the present invention, a method is provided. The method includes determining a plurality of first file digests corresponding to a plurality of files in a file system and providing a directory of the plurality of first file digests.

In another aspect of the present invention, a computer-readable, program storage device is provided, encoded with instructions that, when executed by a computer, perform a method. The method includes determining a plurality of first file digests corresponding to a plurality of files in a file system and providing a directory of the plurality of first file digests.

A more complete understanding of the present invention, as well as a realization of additional advantages and objects thereof, will be afforded to those skilled in the art by a consideration of the following detailed description of the embodiment. Reference will be made to the appended sheets of drawings, which will first be described briefly.

### BRIEF DESCRIPTION OF THE DRAWINGS

The invention may be understood by reference to the following description taken in conjunction with the accompanying drawings, in which the leftmost significant digit(s) in the reference numerals denote(s) the first figure in which the respective reference numerals appear, and in which:

FIGS. 1-14 schematically illustrate various embodiments of a method, a system and a device according to the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

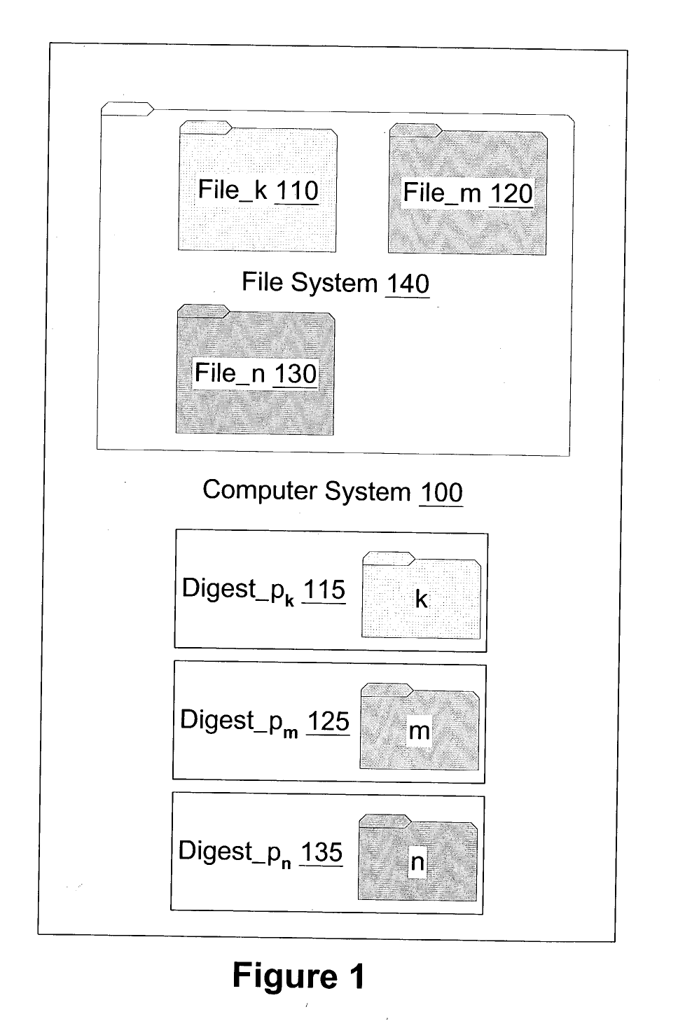

Illustrative embodiments of a method and a device according to the present invention are shown in FIGS. 1-14. Various illustrative embodiments of the present invention show how to locate many files without knowing the individual file names and/or file paths. A “digest” may be calculated for every file in a file system. For example, in one embodiment, the digest is a single number that is derived from a large set of other numbers. In this case, the relevant digests may be calculated from the large set of numbers characterizing every file in the file system. The use here of the term “digest” is substantially similar to the use of the term “digest” in the field of cryptography. For example, in cryptography, the term “message digest” is used to describe a numeric “fingerprint” of a message. As will be appreciated by those of ordinary skill in the art, if a good Digest function is used, there is a vanishingly small chance that two non-identical messages will have the same message digest. Digests may also be applied to any collection of data, such as the state changes a computer applies to a user program running on the computer. Consequently, each file in the file system can have a digest made from the contents of that particular file, for example. In various illustrative alternative embodiments of the present invention, each file in the file system can have a digest made from a preselected subset of the contents of that particular file, for example.

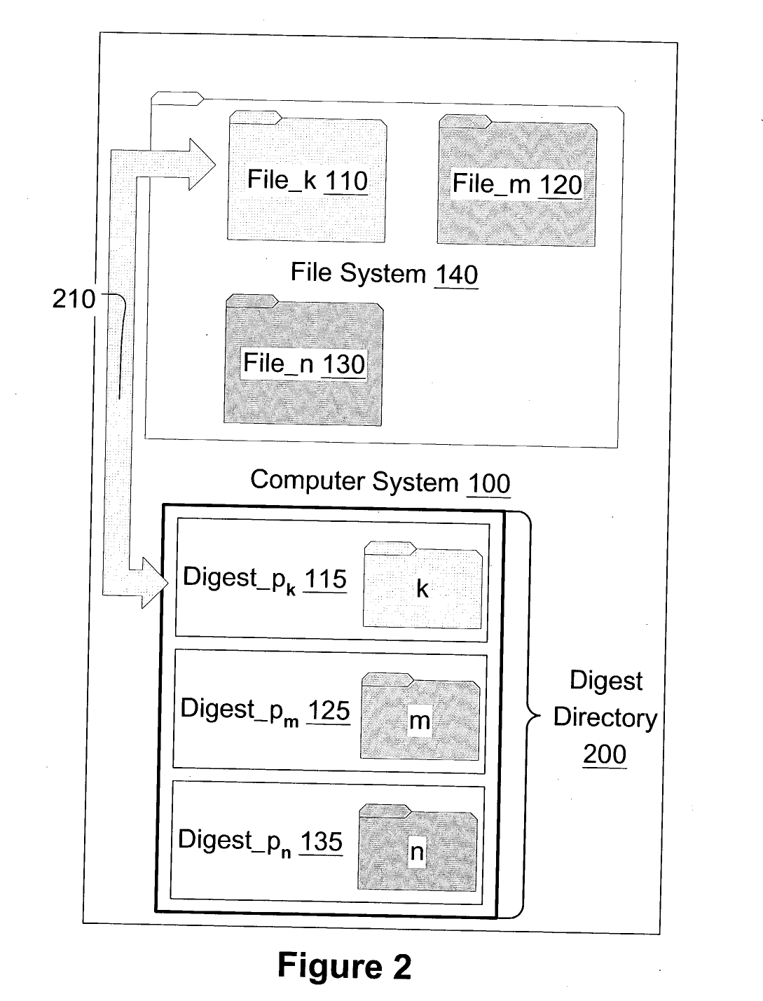

As shown in FIG. 1, in various illustrative embodiments of the present invention, a computer system 100, such as a single computer, a local area network (LAN), a wide area network (WAN), and the like, having a plurality of files (represented here by file_k 110, file_m 120 and file_n 130) in a File System 140. The computer system 100 may calculate a plurality of file digests (represented here by digest_pₖ 115, digest_pₘ 125 and digest_pₙ 135) for every one of the plurality of files in the File System 140 that is only rarely changing. As shown in FIG. 2, the plurality of file digests may be collected together to become a Digest Directory 200 for the File System 140. Each of the plurality of file digests in the Digest Directory 200 may be provided with a file pointer pointing to the file (or the File Name and/or the File Path) to which the respective file digest corresponds. For example, as shown in FIG. 2, the digest_pₖ 115 in the Digest Directory 200 points to the file_k 110 with file pointer 210.

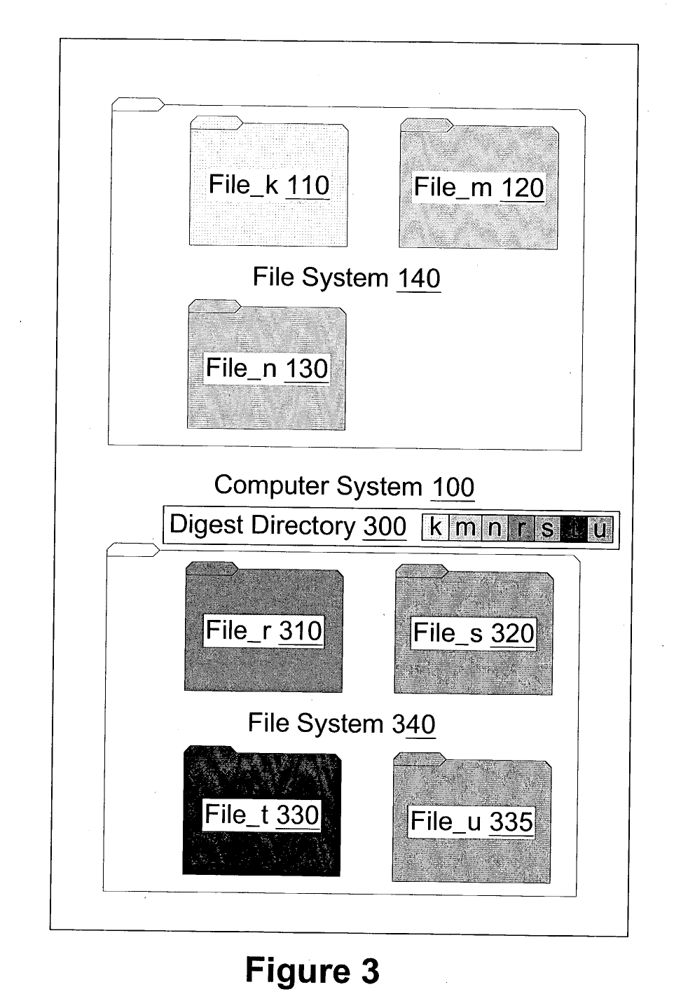

As shown in FIG. 3, in various alternative illustrative embodiments of the present invention, the computer system 100, such as a single computer, a local area network (LAN), a wide area network (WAN), and the like, may have a plurality of files in a plurality of File Systems, represented here by the File System 140 (including the file_k 110, the file_m 120 and the file n_130) and File System 340 (including file_r 310, file_s 320, file_t 330 and file_u 335). The computer system 100 may calculate a plurality of file digests (represented by shaded blocks k, m, n, r, s, t and u) collected together to become the Digest Directory 300 for the File Systems 140 and 340. The Digest Directory 300 has the plurality of file digests (represented by shaded blocks k, m, n, r, s, t and u) corresponding to respective ones of the plurality of the files (file_k 110, file_m 120, file_n 130, file_r 310, file_s 320, file_t 330 and file_u 335) in the File Systems 140 and 340 that are only rarely changing.

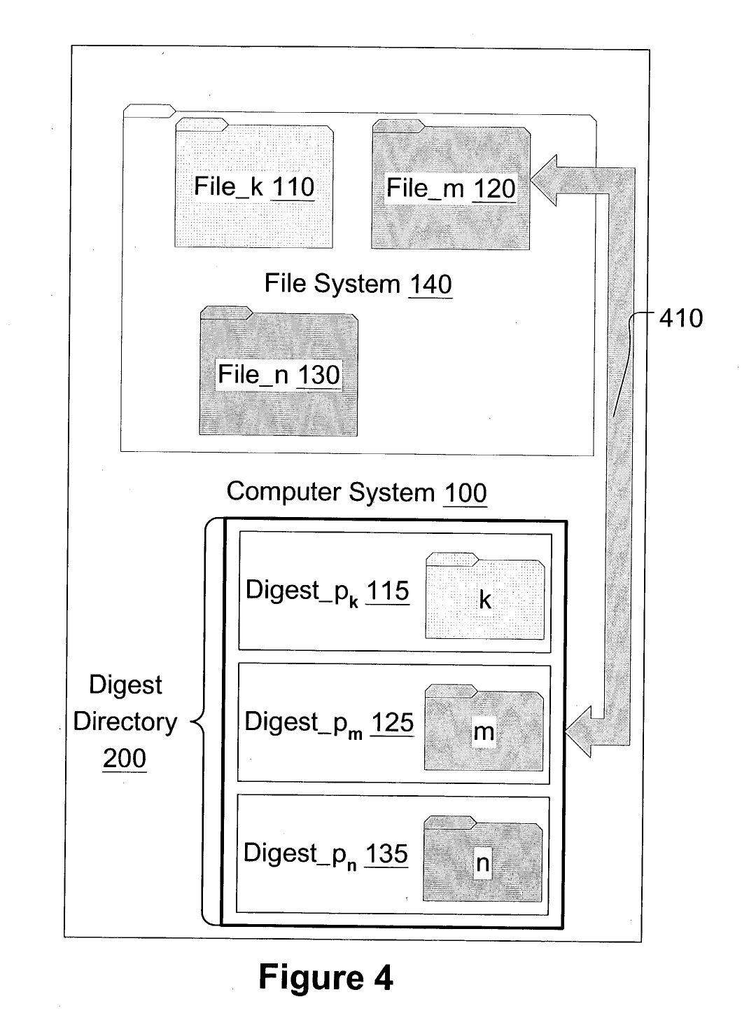

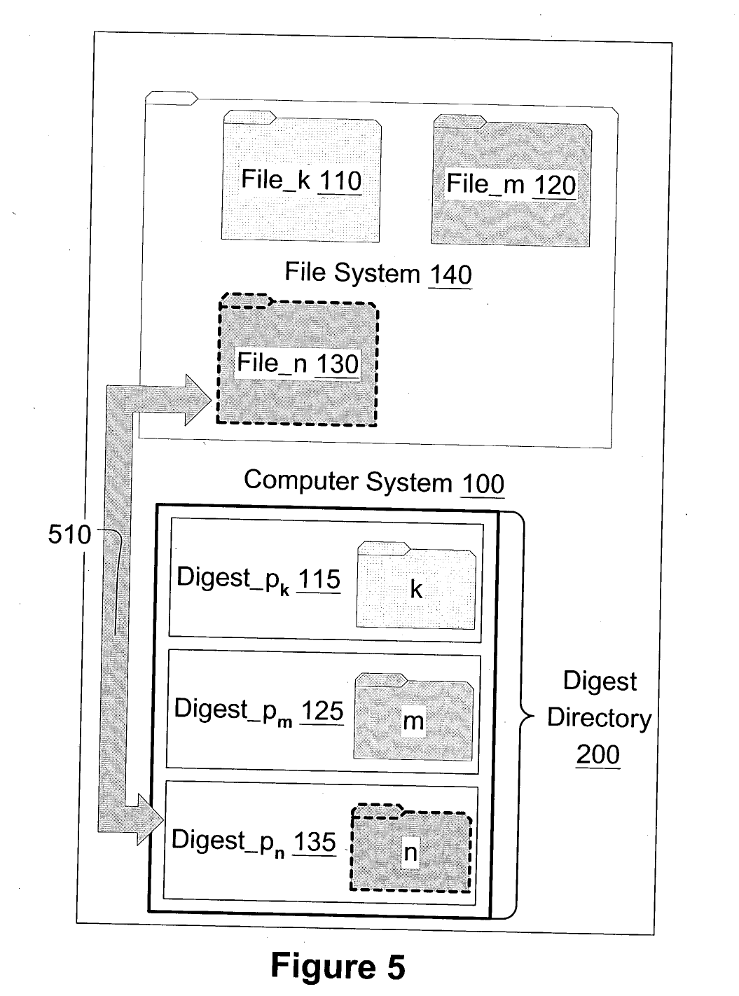

As shown in FIG. 4, the digest_pₘ 125 in the Digest Directory 200 points to the file_m 120 (and/or to the File Name and/or to the File Path) with file pointer 410. As shown in FIG. 5, the digest_p_{—n} 135 in the Digest Directory 200 points to the file_n 130 (and/or to the File Name and/or to the File Path) with file pointer 510. As shown in FIG. 5, in various illustrative embodiments, the Digest Directory 200 may rapidly mark any file of the plurality of the files in the file system having an invalid file digest, such as the digest_pₙ 135 for the file_n 130, the invalidity indicated by the file symbols shown in phantom.

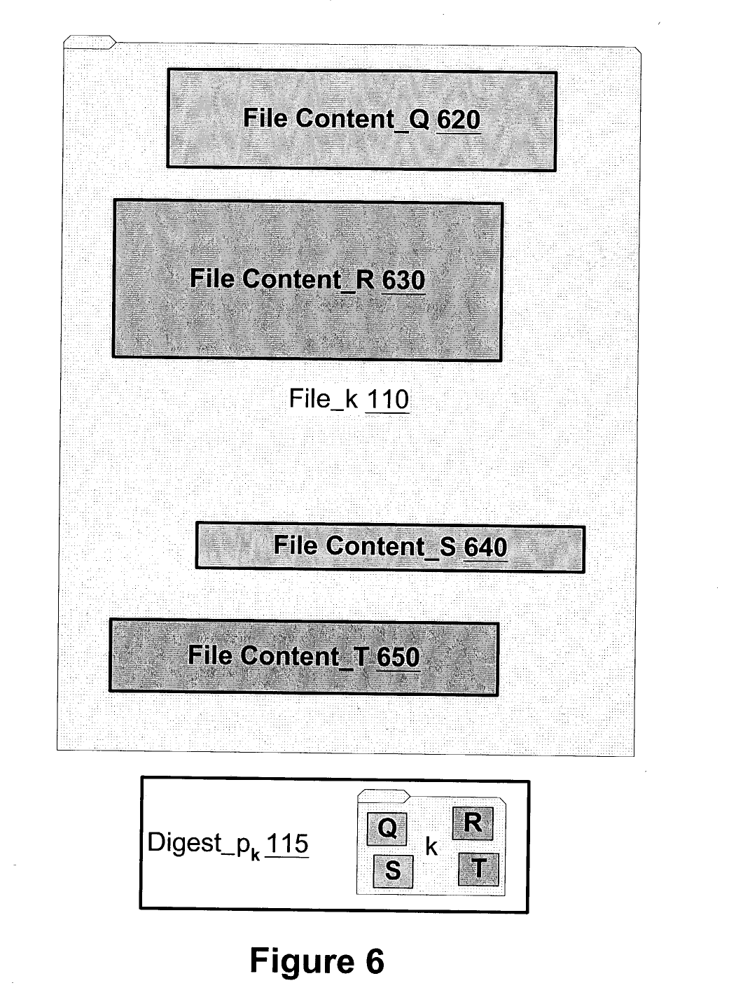

As shown in FIG. 6, in various illustrative embodiments of the present invention, the file_k 110 in the File System 140 (shown in FIGS. 1-5) may have contents depicted by file content_Q 620, file content_R 630, file content_S 640 and file content_T 650. The computer system 100 (shown in FIGS. 1-5) may calculate the file digest for the file_k 110 in the File System 140, represented here by the digest_pₖ 115, the contents of the file_k 110 depicted within the digest_pₖ 115 by the file folders labeled Q, R, S and T.

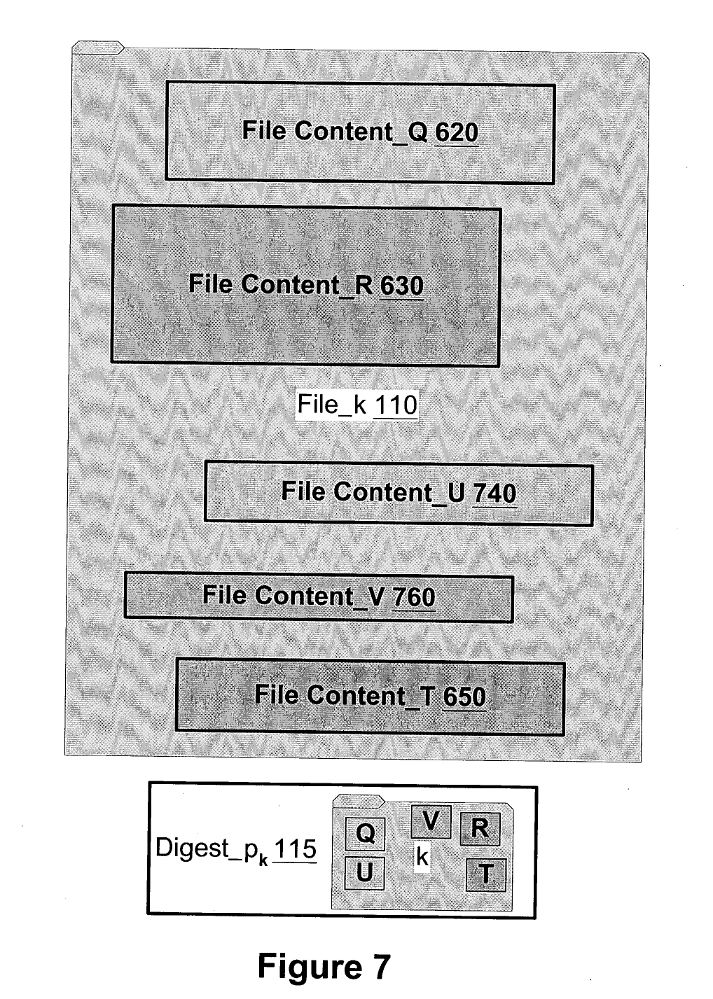

FIG. 7 schematically illustrates a later point in time than the earlier point in time schematically illustrated in FIG. 6. As shown in FIG. 7, in various illustrative embodiments of the present invention, the file_k 110 in the File System 140 (shown in FIGS. 1-5) may have contents depicted by the file content_Q 620, the file content_R 630 and the file content_T 650, unchanged at the later point in time from the earlier point in time schematically illustrated in FIG. 6. The file_k 110 may also have contents depicted by file content_U 740, changed at the later point in time from the file content_S 640 at the earlier point in time schematically illustrated in FIG. 6. The file_k 110 may also have new contents depicted by file content_V 760, newly created at the later point and non-existent at the earlier point in time schematically illustrated in FIG. 6.

The computer system 100 (shown in FIGS. 1-5) may calculate the file digest for the file_k 110 in the File System 140, represented here also by the digest_pₖ 115, but having a numerical value changed at the later point in time from the numerical value of the digest_pₖ 115 calculated at the earlier point in time schematically illustrated in FIG. 6. The contents of the file_k 110 at the later point in time schematically illustrated in FIG. 6 are depicted within the digest_pₖ 115 by the file folders labeled Q, V, R, U and T.

In one embodiment, a new “File Open By Digest” operation may be created. This new File Open By Digest operation may accept as its argument the file digest of the desired file. When called, the File Open By Digest operation may look up the respective file digest in the digest directories, such as the Digest Directory 200 or 300, of all the file systems, such as the File Systems 140 and/or 340, to which the File Open By Digest operation has access.

If the File Open By Digest operation finds one or more matches, the File Open By Digest operation may extract the respective File Name and/or the respective File Path and/or the respective File Pointer, such as the file pointers 210, 410 and/or 510. The File Open By Digest operation may then perform normal File Open operations on the one or more matching files. Normal protection checks may be applied to these normal File Open operations to prevent a user from accessing a file that should be inaccessible. If one of these normal File Open operations fails and there are other files with the same file digest, the File Open By Digest operation may then try these other files until one of the normal File Open operations succeeds or until all of the normal File Open operations fail.

If several places are found from which the one or more matching files may be opened, the File Open By Digest operation may make use of other information to assign a “cost” to each file location. For example, the File Open By Digest operation may make use of measured network speed and/or scan billing records to assign the cost associated with each file location. The File Open By Digest operation may select (or let the user select) the file that is “closest” or less expensive. The File Open By Digest operation may select (or let the user select) the file based on any other criterion.

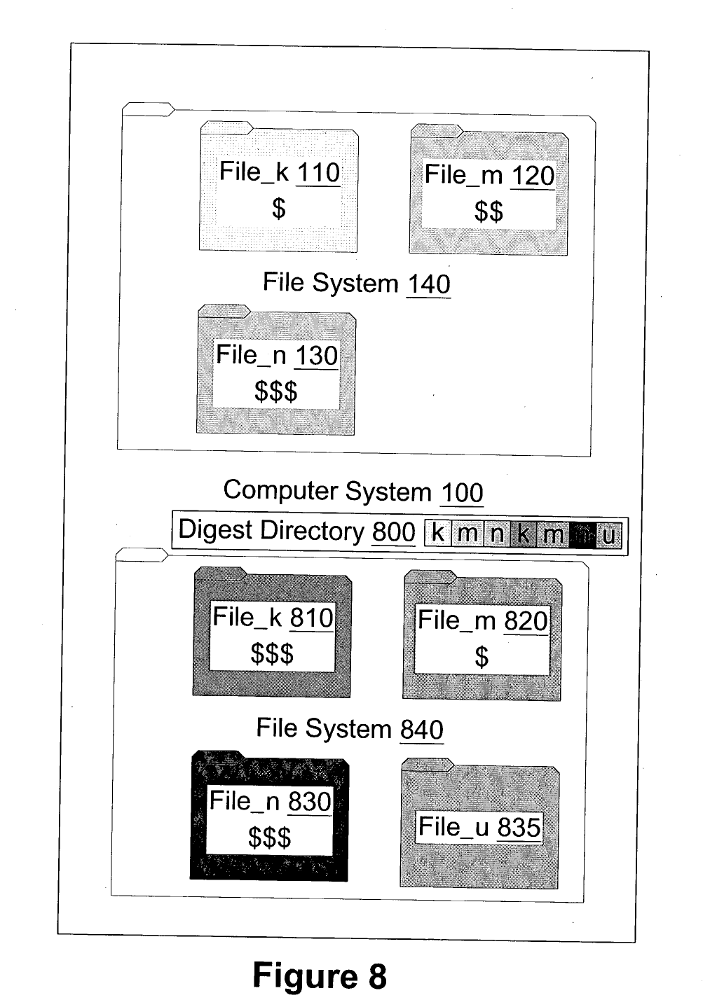

As shown in FIG. 8, for example, in various illustrative embodiments of the present invention, the computer system 100, such as a single computer, a local area network (LAN), a wide area network (WAN), and the like, may have a plurality of files in a plurality of File Systems, represented here by the File System 140 (including the file_k 110, the file_m 120 and the file_n 130) and File System 840 (including file_k 810, file_m 820, file_n 830 and file_u 835). Note that each of the files in the File System 140 (including the file_k 110, the file_m 120 and the file_n 130) is also found in the File System 840 (including file_k 810, file_m 820 and file_n 830). Associated with each of the files found in both the File Systems 140 and 840 is a cost, represented by a number of dollar signs ($), with the number of $ signs signifying the relative cost. For example, the cost associated with opening the file_k 110 in the File System 140 may be represented by only one dollar sign, $, whereas the cost associated with opening the file_k 810 the File System 840 may be represented by three dollar signs, $$$, signifying that opening the file_k 110 in the File System 140 is less expensive than opening the file_k 810 in the File System 840.

The computer system 100 may calculate the plurality of the file digests (represented by differently shaded blocks k, m, n, k, m, n and u) collected together to become the Digest Directory 800 for the File Systems 140 and 840. The Digest Directory 800 has the plurality of the file digests (represented by the differently shaded blocks k, m, n, k, m, n and u) corresponding to respective ones of the plurality of the files (the file_k 110, the file_m 120, the file_n 130, the file_k 810, the file_m 820, the file_n 830 and the file_u 835) in the File Systems 140 and 840 that are only rarely changing. For example, the different costs associated with opening the file_k 110 in the File System 140, on the one hand, and the file_k 810 the File System 840, on the other hand, may be represented by the different shadings for the two blocks labeled k in the Digest Directory 800.

Digests can be expensive to implement. Thus, in one embodiment, it may be desirable to determine the file digest for files that have not changed for a selected time. For example, digests may be calculated for files that only rarely change. However, it will be appreciated that the term “rarely change” may be determined by the particular context in which the present invention is practiced and the definition may vary over time. For example, as computers and computer systems, such as the computer system 100, get faster and as hardware accelerators for calculating Digests become available, it may become feasible to calculate digests for short-lived files. In one embodiment, a background process may be run to scan the file systems, such as the File System 140. The Date Last Modified information may be used to determine when the file was last changed and to decide whether or not to calculate a file digest. In various illustrative embodiments of the present invention, a file digest may be calculated whenever the file is closed and/or sent to a disk or other storage device and/or sent over the network to a remote file system.

A file will have either a current file digest or no current file digest. If a file is opened to allow modification of the file, this opened file must be immediately marked as not having a valid file digest. However, calculating file digests may happen in a “lazy” fashion. The file digest calculation only needs to be performed anytime before the respective file is accessed using its file digest.

A file system, such as the File System 140, that provides the File Open By Digest operation, according to various illustrative embodiments of the present invention, can find files that the user may not be able to find otherwise. Consequently, such a file system can appear more reliable to the user than conventional file systems that depend on File Names. The file system, such as the File System 140, that provides the File Open By Digest operation, allows files to be opened based on the content of the files, since the respective file digests are calculated based on the content of the files.

Since a given file may be available in many locations or places within the computer system 100, the File Open By Digest operation can select between alternative copies to increase performance, decrease cost, and distribute loads or for any other reason, as described above. If one copy of the desired file becomes unavailable, other copies of the desired file may be accessed using the File Open By Digest operation. These copies are known to be identical, since they all share exactly the same file digest, so the program accessing the desired file may switch from one copy to another at will, without worrying about the consistency of the copies.

Files, such as the file_k 110, file_m 120 and file_n 130, with file digests, such as the digest_pₖ 115, digest_pₘ 125 and digest_pₙ 135, respectively, as shown in FIGS. 1 and 2, are not able to be forged. If a program opens a file by the respective file digest using the File Open By Digest operation, the program knows that the file has not been modified. If the file had been modified in any way, the file digest that corresponded to the unmodified file would not point to the modified file, which would almost certainly have an entirely different file digest. The program may perform an additional check by calculating the file digest for the respective file itself to verify that the file does not change between the time that the file is first opened and the time that the file is finished being read. For example, an embodiment of the present invention has been developed so that when a computer user, via one or more computers, opens a file by a first file digest, a second digest for the opened file is calculated. The embodiment then compares and/or matches the first digest with the second digest. If the first and the second digests match, the embodiment determines (or verifies) that the file has not been modified. Conversely, if the first and the second digests do not match, the embodiment determines that the file has been modified.

Files, such as the file_k 110, file_m 120 and file_n 130, with file digests, such as the digest_pₖ 115, digest_pₘ 125 and digest_pₙ 135, respectively, as shown in FIGS. 1 and 2, may each contain a list of files to fetch to complete a set. An embodiment of the present invention has been developed so that a program may provide information on the list of files in the set when the file digest for the respective file is being calculated. If the program opens the file by the respective file digest, using the File Open By Digest operation, the program is provided with the information of the list of files to fetch to complete the set. If a second file in the list has not been fetched, the program may then fetch the second file in the list. For example, an embodiment of the present invention has been developed so that when a computer user, via one or more computers, opens a first file by a file digest, the embodiment is also provided with a list of files to fetch to complete a set. If a second file in that list has not been fetched, the embodiment uses the list and fetches (or opens) the second file.

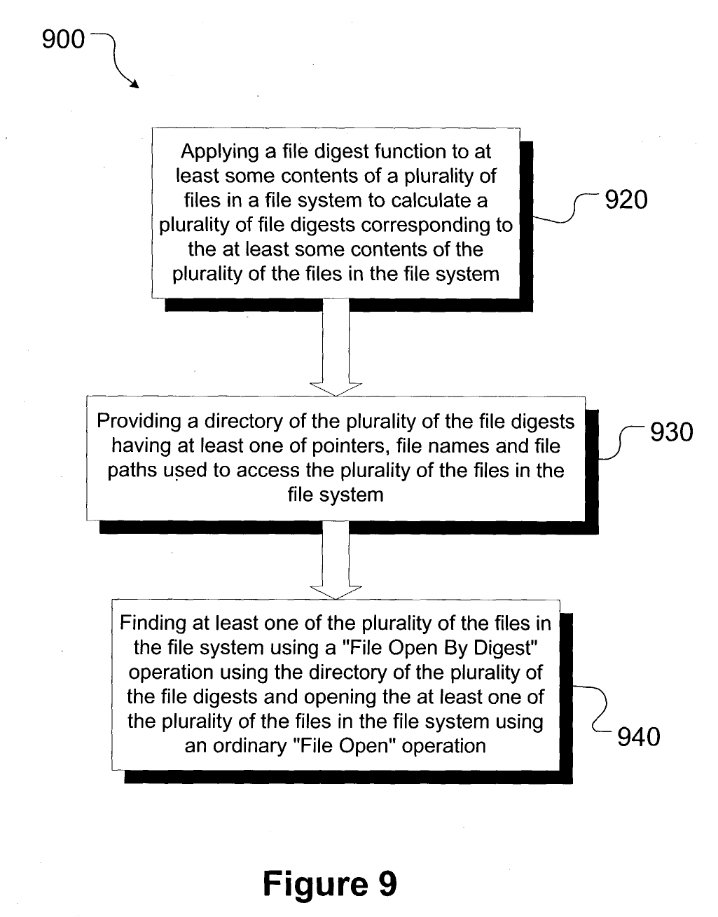

FIGS. 9-14 schematically illustrate particular embodiments of respective methods 900-1400 practiced in accordance with the present invention. FIGS. 1-8 schematically illustrate various exemplary particular embodiments with which the methods 900-1400 may be practiced. For the sake of clarity, and to further an understanding of the invention, the methods 900-1400 shall be disclosed in the context of the various exemplary particular embodiments shown in FIGS. 1-8. However, the present invention is not so limited and admits wide variation, as is discussed further below.

As shown in FIG. 9, the method 900 begins, as set forth in box 920, by applying a file digest function to at least some contents of a plurality of files in one or more file systems to calculate a plurality of file digests corresponding to the at least some contents of the plurality of the files in the file system. For example, as shown in FIGS. 1-8, the computer system 100 may apply a file digest function to at least some of the contents (such as the file content_Q 620, the file content_R 630, the file content_S 640 and/or the file content_T 650) of the file_k 110, as shown in FIG. 6, in the File System 140 shown in FIGS. 1-5. Similarly, the computer system 100 may apply the file digest function to at least some of the contents (not shown) of the plurality of files (such as the file_m 120, the file_n 130, the file_r 310, the file_s 320, the file_t 330 and the file_u 335, as shown in FIGS. 1 and 3) in one or more file systems (such as the File Systems 140 and/or 340) to calculate a plurality of file digests corresponding to at least some of the contents of the plurality of the files in the one or more file systems. For example, the computer system 100 (shown in FIGS. 1-5) may calculate the file digest for the file_k 110 in the File System 140, represented by the digest_pₖ 115, the contents of the file_k 110 depicted within the digest_pₖ 115 by the file folders labeled Q, R, S and T.

The method 900 proceeds by providing a directory of the plurality of the file digests having at least one of pointers, file names and file paths used to access the plurality of the files in the file system, as set forth in box 930. For example, as shown in FIGS. 2-8, The computer system 100 may calculate the plurality of file digests (represented here by the digest_pₖ 115, the digest_pₘ 125 and the digest_pₙ 135) for every one of the plurality of files in the File System 140 that is only rarely changing. As shown in FIG. 2, the plurality of file digests may be collected together to become the Digest Directory 200 for the File System 140. Each of the plurality of file digests in the Digest Directory 200 may be provided with a file pointer pointing to the file (or the File Name and/or the File Path) to which the respective file digest corresponds. For example, as shown in FIG. 2, the digest_pₖ 115 in the Digest Directory 200 points to the file_k 110 with the file pointer 210.

As shown in FIG. 3, in various alternative illustrative embodiments of the present invention, the computer system 100 may calculate the plurality of file digests (represented by the shaded blocks k, m, n, r, s, t and u) collected together to become the Digest Directory 300 for the File Systems 140 and 340. The Digest Directory 300 has the plurality of file digests (represented by shaded blocks k, m, n, r, s, t and u) corresponding to respective ones of the plurality of the files (the file_k 110, the file_m 120, the file_n 130, the file_r 310, the file_s 320, the file_t 330 and the file_u 335) in the File Systems 140 and 340 that are only rarely changing.

As shown in FIG. 4, the digest_pₘ 125 in the Digest Directory 200 points to the file_m 120 (and/or to the File Name and/or to the File Path) with file pointer 410. As shown in FIG. 5, the digest_pₙ 135 in the Digest Directory 200 points to the file_n 130 (and/or to the File Name and/or to the File Path) with file pointer 510. As shown in FIG. 5, in various illustrative embodiments, the Digest Directory 200 may rapidly mark any file of the plurality of the files in the file system having an invalid file digest, such as the digest_pₙ 135 for the file_n 130, the invalidity indicated by the file symbols shown in phantom.

The method 900 then proceeds, as set forth in box 940, by finding at least one of the plurality of the files in the file system using a “File Open By Digest” operation using the directory of the plurality of the file digests and opening the at least one of the plurality of the files in the file system using an ordinary “File Open” operation.

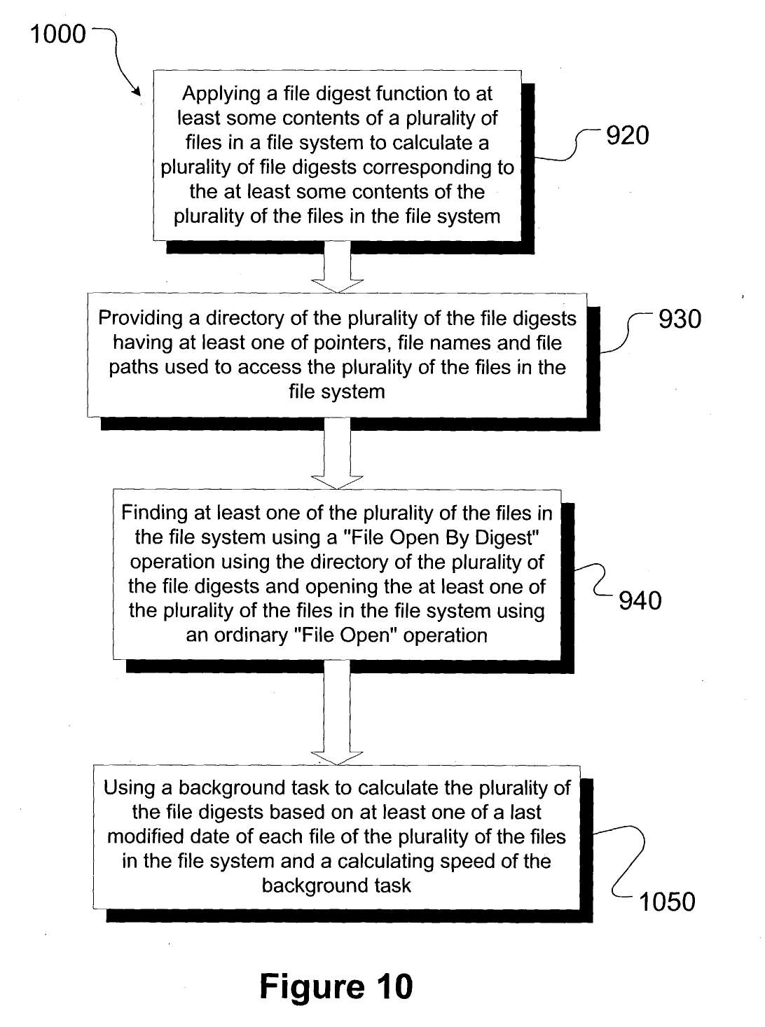

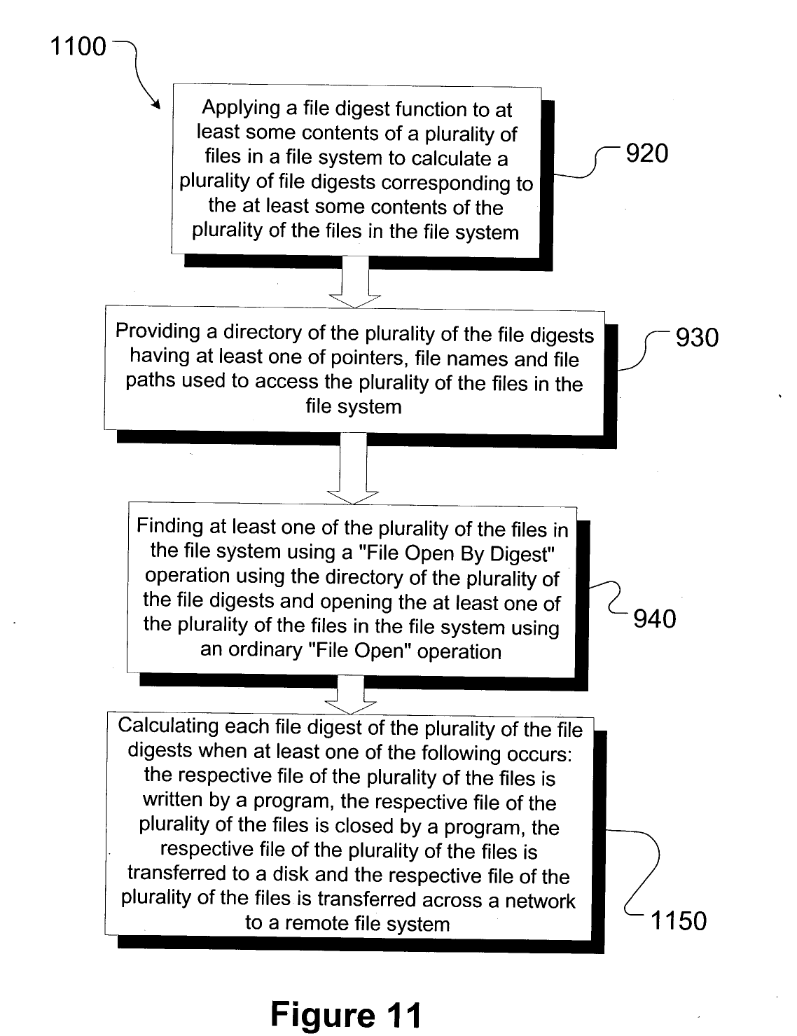

In various illustrative embodiments, as shown in FIG. 10, and as set forth in box 1050 of method 1000, applying the file digest function to the at least some contents of the plurality of the files in the file system to calculate the plurality of the file digests comprises using a background task to calculate the plurality of the file digests based on at least one of a last modified date of each file of the plurality of the files in the file system and a calculating speed of the background task. In various alternative illustrative embodiments, as shown in FIG. 11, and as set forth in box 1150 of method 1100, applying the file digest function to the at least some contents of the plurality of the files in the file system to calculate the plurality of the file digests comprises calculating each file digest of the plurality of the file digests when at least one of the following occurs: the respective file of the plurality of the files is written by a program, the respective file of the plurality of the files is closed by a program, the respective file of the plurality of the files is transferred to a disk and the respective file of the plurality of the files is transferred across a network to a remote file system, such as the File System 340, which may be remote from the File System 110, as shown in FIG. 3.

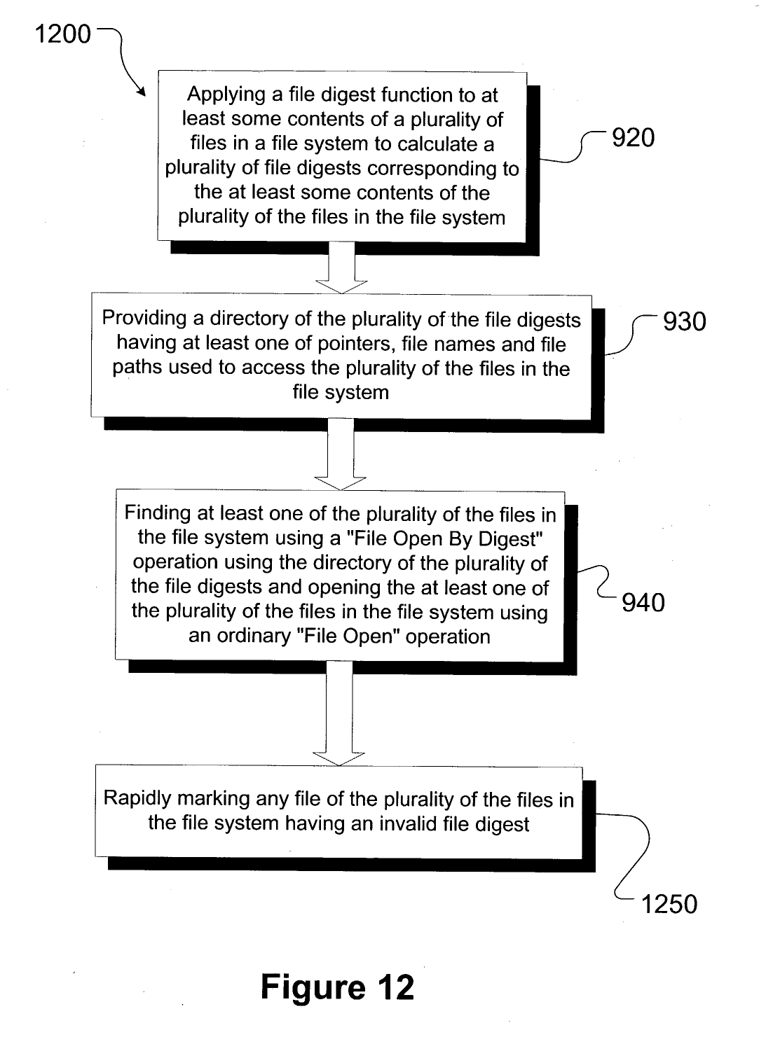

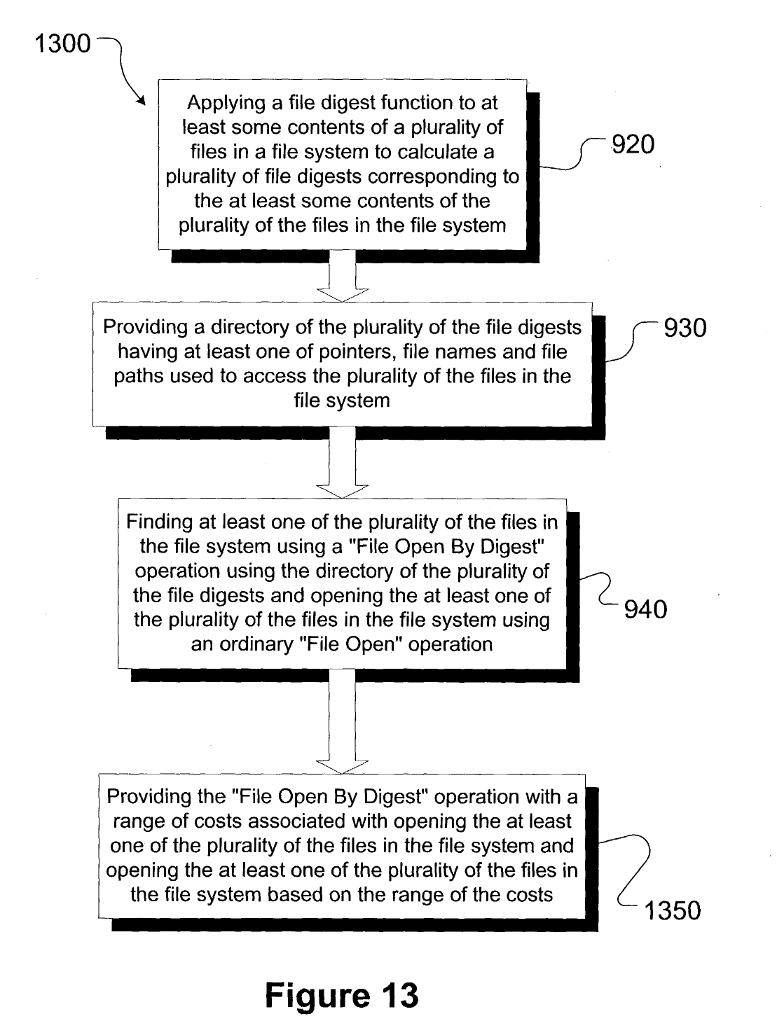

In various illustrative embodiments, as shown in FIG. 12, and as set forth in box 1250 of method 1200, providing the directory of the plurality of the file digests comprises rapidly marking any file of the plurality of the files in the file system having an invalid file digest, as shown in FIG. 5, for example, as described above. In various alternative illustrative embodiments, as shown in FIG. 13, and as set forth in box 1350 of method 1300, finding the at least one of the plurality of the files in the file system using a “File Open By Digest” operation using the directory of the plurality of the file digests comprises providing the “File Open By Digest” operation with a range of costs associated with opening the at least one of the plurality of the files in the file system and opening the at least one of the plurality of the files in the file system based on the range of the costs.

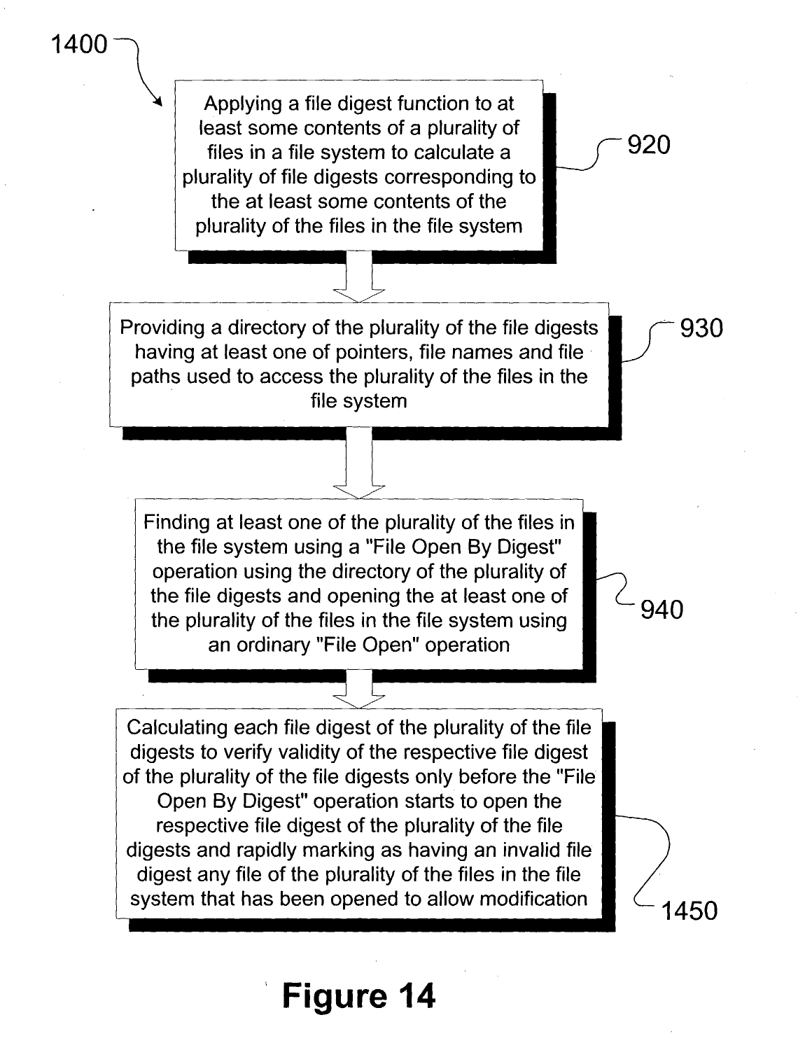

In various alternative illustrative embodiments, as shown in FIG. 14, and as set forth in box 1450 of method 1400, applying the file digest function to the at least some contents of the plurality of the files in the file system to calculate the plurality of the file digests comprises calculating each file digest of the plurality of the file digests to verify validity of the respective file digest of the plurality of the file digests only before the “File Open By Digest” operation starts to open the respective file digest of the plurality of the file digests. Moreover, as set forth in box 1450 of method 1400, providing the directory of the plurality of the file digests comprises rapidly marking as having an invalid file digest any file of the plurality of the files in the file system that has been opened to allow modification, as shown in FIG. 5, for example, as described above.

Any of the above-disclosed embodiments of a method, a system and a device according to the present invention enables a computer user to go to a different computer system than the one the computer user typically uses, where files may be in different places and/or may be mounted differently and/or may have different names, and access the files the computer user needs. Additionally, any of the above-disclosed embodiments of a method, a system and a device according to the present invention enables the computer user to be able to find files the computer user needs without knowing the file name and/or file path, and, so will be able to get work done.

Moreover, an embodiment of the invention can be implemented as computer software in the form of computer readable program code executed in a general purpose computing environment; in the form of bytecode class files executable within a Java™ run time environment running in such an environment; in the form of bytecodes running on a processor (or devices enabled to process bytecodes) existing in a distributed environment (e.g., one or more processors on a network); as microprogrammed bit-slice hardware; as digital signal processors; or as hard-wired control logic.

An embodiment of the invention can be implemented within a client/server computer system. In this system, computers can be categorized as two types: servers and clients. Computers that provide data, software and services to other computers are servers; computers that are used to connect users to those data, software and services are clients. In operation, a client communicates, for example, requests to a server for data, software and services, and the server responds to the requests. The server's response may entail communication with a file management system for the storage and retrieval of files.

The computer system can be connected through an interconnect fabric. The interconnect fabric can comprise any of multiple, suitable communication paths for carrying data between the computers. In one embodiment the interconnect fabric is a local area network implemented as an intranet or Ethernet network. Any other local network may also be utilized. The invention also contemplates the use of wide area networks, the Internet, the World Wide Web, and others. The interconnect fabric may be implemented with a physical medium, such as a wire or fiber optic cable, or it may be implemented in a wireless environment.

In general, the Internet is referred to as an unstructured network system that uses Hyper Text Transfer Protocol (HTTP) as its transaction protocol. An internal network, also known as intranet, comprises a network system within an enterprise. The intranet within an enterprise is typically separated from the Internet by a firewall. Basically, a firewall is a barrier to keep destructive services on the public Internet away from the intranet.

The internal network (e.g., the intranet) provides actively managed, low-latency, high-bandwidth communication between the computers and the services being accessed. One embodiment contemplates a single-level, switched network with cooperative (as opposed to competitive) network traffic. Dedicated or shared communication interconnects may be used in the present invention.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. In particular, every range of values (of the form, “from about a to about b,” or, equivalently, “from approximately a to b,” or, equivalently, “from approximately a-b”) disclosed herein is to be understood as referring to the power set (the set of all subsets) of the respective range of values, in the sense of Georg Cantor. Accordingly, the protection sought herein is as set forth in the claims below.

What is claimed:

1. A method, comprising:
determining a plurality of first file digests corresponding to a plurality of files in a file system; and
providing a directory of the plurality of first file digests.

2. The method of claim 1, wherein each of the plurality of files comprises contents and wherein determining the plurality of first file digests further comprises applying a first file digest function to at least a portion of the contents of each of the plurality of files.

3. The method of claim 1, wherein each of the plurality of files comprises contents and wherein determining the plurality of first file digests further comprises applying a first file digest function to substantially the entire contents of each of the plurality of files.

4. The method of claim 1, wherein determining the plurality of first file digests further comprises identifying each of the plurality of files that has changed within a preselected period of time and applying a first file digest function to at least the identified files.

5. The method of claim 4, wherein applying the first file digest function to at least the identified files comprises applying the first file digest function to only the identified files.

6. The method of claim 4, wherein identifying each of the plurality of files changed within the preselected period of time further comprises identifying each of the plurality of files changed within a preselected period of time using a background task adapted to access a modification date of each of the plurality of files.

7. The method of claim 6, wherein applying the first file digest function to at least the identified files further comprises selecting a portion of the plurality of files including at least the identified files using a calculating speed of the background task.

8. The method of claim 1, wherein determining the plurality of first file digests comprises determining the first file digests when one of the plurality of files is opened.

9. The method of claim 1, wherein determining the plurality of first file digests comprises determining the first file digests when one of the plurality of files is closed.

10. The method of claim 1, wherein determining the plurality of first file digests comprises determining the first file digests when one of the plurality of files is sent to a storage device.

11. The method of claim 1, wherein determining the plurality of first file digests comprises determining the first file digests before one of the plurality of files is sent over a network to a remote file system.

12. The method of claim 1, further comprising determining a location of at least one of the plurality of the files in the file system using the directory of the plurality of the first file digests.

13. The method of claim 12, wherein determining the location of at least one of the plurality of the files in the file system comprises determining the location of at least one of the plurality of the files in the file system using at least one of a pointer, a file name, and a file path associated with the corresponding first file digest stored in the directory.

14. The method of claim 12, further comprising opening the at least one of the plurality of the files in the file system.

15. The method of claim 14, where opening the at least one of the plurality of files comprises opening the at least one of the plurality of files using an ordinary “File Open” operation.

16. The method of claim 14, wherein opening the at least one of the plurality of files comprises determining a second file digest of the file.

17. The method of claim 16, wherein opening the at least one of the plurality of files comprises comparing the first file digest and the second file digest to verify that at least one of the plurality of files has not changed.

18. The method of claim 14, wherein opening the at least one of the plurality of the files in the file system comprises determining a range of costs associated with opening the at least one of the plurality of the files in the file system.

19. The method of claim 18, wherein opening the at least one of the plurality of the files in the file system comprises opening the at least one of the plurality of the files in the file system based on the determined range of the costs.

20. The method of claim 1, wherein determining the plurality of first file digests comprises determining a list of files to fetch for each first file digest to complete a set of files.

21. The method of claim 20, further comprising:
determining a location of a first file of the plurality of the files in the file system using the directory of the plurality of the first file digests;
opening the first file of the plurality of the files in the file system; and
opening a second file in the file system using the list of files determined for the corresponding first file digest associated with the first file.

22. The method of claim 1, wherein providing the directory of the plurality of the file digests comprises rapidly marking any file of the plurality of the files in the file system having an invalid file digest.

23. The method of claim 1, wherein the plurality of files in the file system are connected with a network and wherein the plurality of first file digest and the directory of the plurality of first file digests are provided via the network.

24. The apparatus of claim 23, wherein the network comprises a wide area network and a local area network.

25. The apparatus of claim 24, wherein the plurality of files are separated from the wide area network through a firewall.

26. A computer-readable, program storage device, encoded with instructions that, when executed by a computer, perform a method comprising:
determining a plurality of first file digests corresponding to a plurality of files in a file system; and
providing a directory of the plurality of first file digests.

27. The computer-readable, program storage device of claim 26, encoded with instructions that, when executed by a computer, perform the method further comprising determining a location of at least one of the plurality of the files in the file system using the directory of the plurality of the first file digests.

28. The computer-readable, program storage device of claim 27, encoded with instructions that, when executed by a computer, perform the method further comprising opening the at least one of the plurality of the files in the file system.

29. An apparatus, comprising:
means for determining a plurality of first file digests corresponding to a plurality of files in a file system; and
means for providing a directory of the plurality of first file digests.

30. The apparatus of claim 29, further comprising means for determining a location of at least one of the plurality of the files in the file system using the directory of the plurality of the first file digests.

31. The apparatus of claim 30, further comprising means for opening the at least one of the plurality of the files in the file system.

32. The apparatus of claim 31, further comprising means determining a second file digest of the file after opening the at least one of the plurality of files.

33. The apparatus of claim 32, further comprising means for comparing the first file digest and the second file digest to verify that at least one of the plurality of files has not changed.
